(19) United States
(12) Patent Application Publication
(10) Pub. No.: US 2007/0288291 A1
(43) Pub. Date: Dec. 13, 2007

(54) System and method for dynamic meeting notification

(76) Inventor: Kevin C. Earle, Washington, IL (US)

Correspondence Address: Caterpillar Inc.;Intellectual Property Dept., AB 6490, 100 N.E. Adams Street, PEORIA, IL, 61629-6490, US

(21) Appl. No.: 11/451,080

(22) Filed: Jun. 12, 2006

(51) Int. Cl. G06F 15/02

(52) U.S. Cl. 705/9

(57) ABSTRACT

A method and system for providing notification of scheduled meetings in a meeting room. The method includes determining that a first meeting has been scheduled in a meeting room and that another meeting has been scheduled or is occurring in the meeting room within a predetermined time range prior to the first meeting. An automatic notification may then be provided in the meeting room as a function of the predetermined time range.

### TECHNICAL FIELD

The present invention relates generally to a system and method of providing a notification of upcoming meetings in a meeting room and more particularly with a system and method of notifying meeting participants of an upcoming meeting using a networked environment.

### BACKGROUND

Various resources, such as meeting rooms or other types of rooms in a business or organizational setting, may be shared by numerous users. These types of resources are typically limited resources in which the demand may often exceed the number of meeting rooms that are available or the time that is scheduled for the meeting. With these limited meeting room resources, reservation systems are used to allow users to reserve these types of resources for a certain range of time.

A user may schedule appointments, meetings and scheduling actions using a number of different software packages available on the market, such as Lotus Notes™, and Microsoft Outlook™. The user may also accept appointments, meetings, and scheduling actions sent by other users. The above referenced scheduling, or calendaring, systems allow for a convenient and organized method of keeping track of one's schedule, and the allocation of meeting room resources.

Presently, if a user wants to schedule a meeting with two or more other people, the user would open their calendar, select “schedule meeting”, select the people to be invited to the meeting, select a room based upon the number of people invited and additional resources needed, find a time range to meet based upon the attendees and resource availability and then send the meeting invitation requesting a confirmation of the meeting time and meeting room. The user typically schedules the time range of the meeting based upon availability of meeting rooms and meeting participants, a proposed agenda, and the like.

Sometimes the scheduled time range is sufficient, and sometimes it is not. This may cause the participants of the meeting to desire to stay in the meeting room beyond the scheduled time to continue the meeting, not knowing if there is another meeting scheduled that will require them to leave the meeting room. Regardless, if the meeting is going past the scheduled time, they may continue the meeting unless someone notifies them that another meeting is waiting to start. Additionally, with today's technology of computers and overhead projectors to facilitate meetings, time is required to shut down equipment and to pack up other items. All of these issues lead to meetings that go beyond the scheduled time range causing subsequently scheduled meetings to have a delayed start.

The present invention is directed to overcoming one or more of the problems set forth above.

### SUMMARY OF THE INVENTION

It is to be understood that both the foregoing general description and the following detailed description are exemplary and explanatory only and are not restrictive of the invention as claimed.

In one aspect of the present invention, a method for providing notification in a meeting room of a scheduled meeting is disclosed. The method includes the steps of determining that a first meeting has been scheduled in a meeting room, the first meeting having a first start time and a first end time and providing at least one automatic notification in the meeting room of the first meeting at a predetermined time prior to the first start time.

In another aspect of the present invention, a system for providing notification of scheduled meetings is disclosed. This system comprises a scheduling system including a scheduling module, a time range module, and a notification module and a notification system operably connected to the notification module. The scheduling module schedules a first meeting in a meeting room having a first start time and a first end time and a second meeting in the meeting room having a second start time and a second end time. The time range module determines that the first start time and the second end time are within a predetermined time range. The notification module determines that a notification of the second end time should be made in the meeting room.

### BRIEF DESCRIPTION OF THE DRAWINGS

The accompanying drawings, which are incorporated in and constitute a part of this specification, illustrate embodiments of the invention and, together with the description, serve to explain the principles of the invention. In the drawings,

FIG. 1 is a block diagram illustrating components used in the scheduling of resources and providing notification in meeting rooms in accordance with one embodiment of the invention; and

FIG. 2 is a flowchart of the steps involved in providing an automated notification in a meeting room of a scheduled meeting according to one embodiment of the invention.

### DETAILED DESCRIPTION

Reference will now be made in detail to embodiments of the invention, examples of which are illustrated in the accompanying drawings. Whenever possible, the same reference numbers will be used throughout the drawings to refer to the same or like parts.

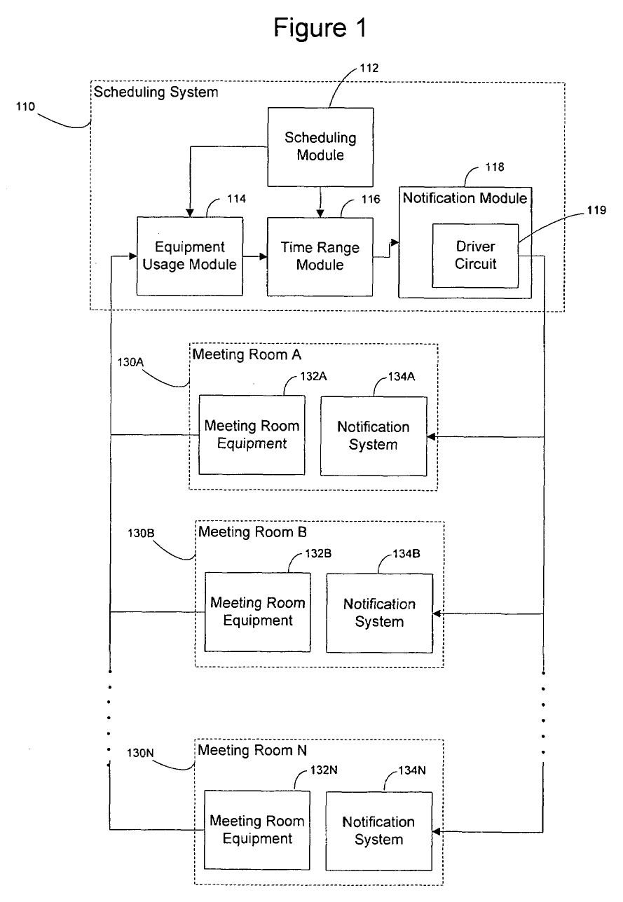

Referring to FIG. 1, there is shown a block diagram illustrating components used in the scheduling of resources and providing notification in meeting rooms 130 in accordance with one embodiment of the invention. The block diagram is shown to include a scheduling system 110. The scheduling system 110 may be part of a software system on a computer, such software system having calendaring, or scheduling, capabilities or may be an independent software package that may tie into separate scheduling systems.

The scheduling system 110 may include various modules, including a scheduling module 112, an equipment usage module 114, a time range module 116, a notification module 118, and the like. The scheduling module 112 may be configured such that a meeting room user is able to input requests for resources for a period of time, that period of time having a start time and an end time. These resources may include a plurality of meeting rooms 130A, 130B, 130N as well as various sets of meeting room equipment 132A, 132B, 132N. Meeting room equipment 132 may include computers, projectors, video equipment, white boards, dry erase markers, and the like. For those meetings where meeting room equipment 132 is requested, the scheduling system 112 may be configured to schedule the time required to shut down the meeting room equipment 132 such that other meeting room users cannot schedule into that time.

The equipment usage module 114 may be configured to determine the meeting room equipment 132 that may be requested, or required, for scheduled meetings. The equipment usage module 114 may pull requests that were input into the scheduling module 112 for meeting room equipment 132 for a meeting room 130. The equipment usage module 114 may also be configured to detect certain meeting room equipment 132 being used in a given meeting room 130, such as a projector being in use, a laptop being connected to the network, and the like.

The time range module 116 may be configured to receive, or query, meeting start and end times from the scheduling module 112 and determine if the end time of one meeting and the start time of a subsequent meeting in the same meeting room 130 are within a predetermined time range. The time range module 116 may also be configured to pull requested sets of meeting room equipment 132 from the scheduling module 112 for the first or second meetings or pull data from the equipment usage module 114 to determine if any meeting room equipment 132 is currently being used in the meeting room 130. The amount of meeting room equipment 132 requested for use or currently being used in the meeting room 130 may cause the predetermined time range to be adjusted. For example, if no meeting room equipment 132 is requested during the first meeting or is being used currently in the second, prior meeting, the predetermined time range will be minimal. If meeting room equipment 132 is only scheduled during the first meeting, the predetermined time range may be longer. If the meeting room equipment 132 is requested to be used or is currently being used during the second meeting and not the first meeting, the predetermined time range may be longer yet. If meeting room equipment 132 is requested for the first meeting and was requested or is being used for the second meeting, the predetermined time range may be a maximum. It is contemplated that if the end time of one meeting and the start time of the subsequent meeting are within the predetermined time range, the scheduling system 110 may be configured to alter the start time of the first meeting as a function of the predetermined time range. This may be dependent upon if the earlier meeting was already scheduled.

The notification module 118 may be configured to receive, or query, the time range module 116 for scheduled meetings in a meeting room 130 that have an end time and a start time within the predetermined time range or for scheduled meetings that currently have meeting room users in the meeting room within the predetermined time range who may not have scheduled a meeting. If it is determined that one of these conditions exists, the notification module 118 may trigger a notification system 134 to provide notification in the meeting room 130. The notification system 134 may be triggered using a driver circuit 119, such as drivers for electrical equipment. Exemplary driver circuits are known in the art. Each notification system 134A, 134B, 134N in each meeting room 130A, 130B, 130N may be a specific alarm for notification, an automated phone message, a phone ring, flashing of the room lights, a specific notification light, an indication projected upon the screen if the projector is in use, an e-mail to detected laptops being used in the room, and the like. The notification system 134 may be triggered once or even multiple times. For example, if it is determined that meeting room equipment 132 is being used in the meeting room 130, a notification may be given to meeting room users that their meeting ends, or that a subsequent meeting begins, in 10 minutes. A second notification may also be given at 5 minutes. A third notification may also be given at one minute. These additional notifications may be provided after determining that the meeting room equipment 132 is still being used. If it is determined that the meeting room equipment 132 has been shut down, then the notification at 5 minutes may not be given, but merely a notification at 1 minute prior to the end time to vacate the meeting room 130. These additional notifications may also be dependent upon determining whether meeting room users are still in the meeting room 130. It is noted that various other combinations of notice types and times may be used as well.

### INDUSTRIAL APPLICABILITY

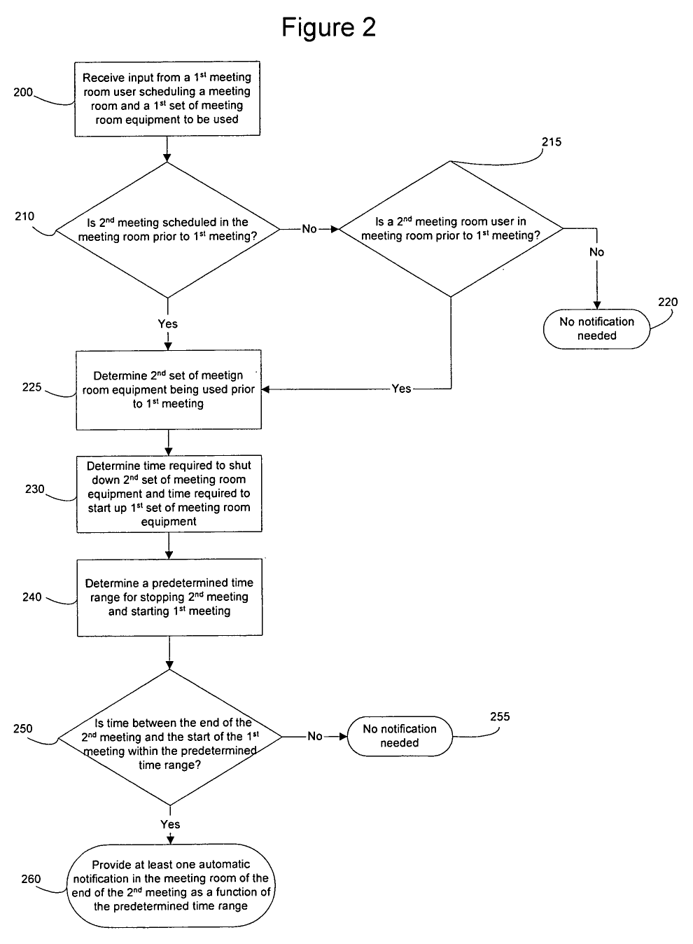

Referring to FIG. 2, there is depicted a flowchart of the steps involved in providing an automatic notification in a meeting room 130 of a scheduled meeting according to one embodiment of the invention. The process may begin when input is received from a first meeting room user to schedule a meeting room 130 and a first set of meeting room equipment 132 to use in that first meeting (step 200). The time range module 116 may then pull information from the scheduling module 112 to determine if a second meeting is scheduled to occur prior to the first meeting (step 210).

If a second meeting is not scheduled prior to the first meeting, the time range module 116 may try to pull information to determine if there is a second meeting room user in the meeting room 130 prior to the first meeting (step 215). If neither of these conditions exist, then no notification is needed (step 220). If one or both of these conditions exist, then the time range module 116 may pull information from the scheduling module 112 or the equipment usage module 114 to determine if a second set of meeting room equipment 132 was scheduled to be used or is currently being used (step 225). The time range module 116 may then determine the necessary time required to shut down the second set of meeting room equipment 132 and the time required to start up the first set of meeting room equipment 132 (step 230).

The time range module 116 may then determine a predetermined time range for stopping the second meeting and beginning the first meeting (step 240). The notification module 118 may then determine if the time between the end of the second meeting and the start of the first meeting is within the predetermined time range (step 250). If the time between the meetings is not within the predetermined time range, no notification is needed (step 255). If the time between the meetings is within the predetermined time range, then the notification module 118 may trigger the notification system 134 to provide at least one automatic notification in the meeting room signaling the end of the second meeting, or the start of the first meeting, as a function of the predetermined time range (step 260).

It will be apparent to those skilled in the art that various modifications and variations can be made in the system and method of the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A method for providing notification in a meeting room of a scheduled meeting, comprising:
determining that a first meeting has been scheduled in a meeting room, the first meeting having a first start time and a first end time; and
providing at least one automatic notification in the meeting room of the first meeting at a predetermined time prior to the first start time.

2. The method, as set forth in claim 1, further comprising:
determining that a meeting room user is in the meeting room prior to the start time.

3. The method, as set forth in claim 1, wherein the predetermined time is a function of equipment being used in the meeting room.

4. The method, as set forth in claim 1, further comprising:
determining that a second meeting is scheduled in the meeting room, the second meeting having a second start time and a second end time;
determining that the second end time and the first start time are within a predetermined time range; and
providing the at least one automatic notification of the second end time as a function of the predetermined time range.

5. The method, as set forth in claim 4, further including:
determining a first set of equipment scheduled for used in the first meeting; and
determining a second set of equipment being used in the second meeting.

6. The method, as set forth in claim 5, wherein the predetermined time range is a function of at least one of the first and second sets of equipment.

7. The method, as set forth in claim 5, wherein determining the first and second sets of equipment includes receiving at least one of a first set of equipment requirements from a first meeting room user and a second set of equipment requirements from a second meeting user.

8. The method, as set forth in claim 4, further comprising:
receiving at least one of a first set of equipment requirements from a first meeting room user and a second set of equipment requirement from a second meeting room user.

9. The method, as set forth in claim 8, wherein the predetermined time range is a function of at least one of the first and second equipment requirements.

10. The method, as set forth in claim 4, wherein the first start time is altered as a function of the predetermined time range.

11. A system for providing notification of scheduled meetings, comprising:
a scheduling system including:
a scheduling module for scheduling a first meeting in a meeting room having a first start time and a first end time and a second meeting in the meeting room having a second start time and a second end time;
a time range module for determining that the first start time and the second end time are within a predetermined time range; and
a notification module for determining that a notification of the second end time should be made in the meeting room; and
a notification system in the meeting room, the notification system operably connected to the notification module.

12. The system, as set forth in claim 11, the scheduling system further comprising:
an equipment usage module for determining an equipment requirement for at least one of the first and second meetings.

13. The system, as set forth in claim 12, wherein the equipment usage module inputs the equipment requirement for the meeting room to the time range module to modify the predetermined time range.

14. The system, as set forth in claim 12, wherein at least one of a first and second meeting room users input the equipment requirement for at least one of the first and second meetings.

15. The system, as set forth in claim 12, wherein the equipment usage module detects the equipment being used in the meeting room during at least one of the first and second meetings.

16. The system, as set forth in claim 11, wherein the notification system is operable to provide notification of the first end time.

17. A method for receiving notification of a scheduled meeting, comprising:
using a meeting room for a first purpose;
receiving an automatic notification in the meeting room at a predetermined time prior to a start time of a scheduled meeting, the automated notification being provided as a function of the predetermined time; and
leaving the meeting room prior to the start time.

18. The method, as set forth in claim 17, wherein the predetermined time is a function of at least one of a first set of equipment being used in the meeting room for the first purpose and a scheduled set of equipment for the scheduled meeting.
